(19) United States
(12) Patent Application Publication
(10) Pub. No.: US 2016/0035255 A1
(43) Pub. Date: Feb. 4, 2016

(54) Advertisement Shelving Unit

(71) Applicant: Jon Randolph Marler, Syracuse, IN (US)

(72) Inventor: Jon Randolph Marler, Syracuse, IN (US)

(73) Assignees: MIDWEST WIRE PRODUCTS LLC, Marion, IN (US); Jon Randolph Marler, Syracuse, IN (US)

(21) Appl. No.: 14/816,357

(22) Filed: Aug. 3, 2015

Related U.S. Application Data
(60) Provisional application No. 62/031,912, filed on Aug. 1, 2014.

(51) Int. Cl. G09F 3/20; A47F 5/10; A47F 5/00

(52) U.S. Cl. CPC G09F 3/204; A47F 5/0018; A47F 5/10

(57) ABSTRACT

An advertisement shelving unit is used to store and display products while also presenting advertisements to attract consumers. The advertisement shelving unit includes a plurality of vertical supports which are used for stacking at least one shelf. The at least one shelf is used for bearing the weight of products. The advertisement shelving unit also includes a header unit which is positioned near a top end of each of the vertical supports and is used primarily as advertising space. The header unit and the at least one shelf include a plurality of lateral cross members which are attached in between two adjacent vertical supports to hold the plurality of vertical supports together. The advertisement shelving unit also includes a plurality of advertisement assemblies which are attached to selected members of the plurality of lateral cross members to attract consumers.

The current application claims a priority to the U.S. Provisional Patent application Ser. No. 62/031,912 filed on Aug. 1, 2014.

### FIELD OF THE INVENTION

The present invention relates generally to shelving units. More specifically, the present invention is an advertisement shelving unit which is used to display products and advertise products to consumers.

### BACKGROUND OF THE INVENTION

Sales presentation is a very important factor in generating revenue and properly displaying a product to the consumer. “POP” or point of purchase displays often act as a “silent salesman” for the marketplace to sell an item without having an individual to pitch the product. The point of purchase display has become very popular throughout many storefronts, however some specific types of stores often require a specialized type of POP displays. Standard shelving units do not adequately allow for customization based on changes in sales or product inventory.

The present invention is advertisement shelving unit which is used for displaying products through a point of purchase system. The present invention is designed for retail applications both inside and outside locations. The advertisement shelving unit features removable advertisement assemblies which may be interchanged to support the display of varying products. The present invention improves upon existing inventions by creating a way to easily decorate otherwise unmarked shelving units with customized advertisements for any occasion.

### BRIEF DESCRIPTION OF THE DRAWINGS

FIG. 1 is a perspective view of the present invention.

FIG. 2 is an exploded perspective view of the present invention.

FIG. 3 is an exploded perspective view showing how a lateral cross member, vertical supports, and an advertisement assembly are assembled together.

FIG. 4 is a front view of the present invention.

FIG. 5A is a front view showing the lateral cross member for a header unit.

FIG. 5B is a front view showing the lateral cross member for a shelf.

FIG. 6A is a front view showing the sheet body of a header advertisement assembly.

FIG. 6B is a front view showing the sheet body of a shelf advertisement assembly.

### DETAILED DESCRIPTION OF THE INVENTION

All illustrations of the drawings are for the purpose of describing selected versions of the present invention and are not intended to limit the scope of the present invention.

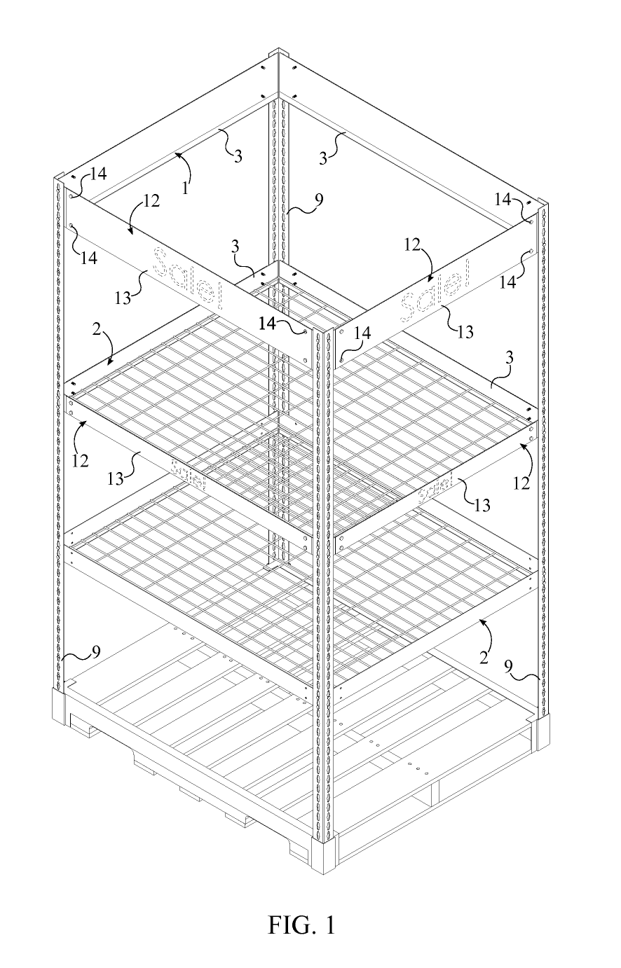

With reference to FIGS. 1-2 and 7-8, the present invention is an advertisement shelving unit that is used to support and display goods sold in stores. The present invention is also used to easily display advertisements or information related to products stored on the advertisement shelving unit. The present invention comprises a header unit 1, at least one shelf 2, a plurality of vertical supports 9, and a plurality of advertisement assemblies 12. The plurality of vertical supports 9 is used as a means of vertically stacking the at least one shelf 2 and the header unit 1. Each of the plurality of vertical supports 9 is held in a fixed orientation by the at least one shelf 2 and the header unit 1. The header unit 1 is used primarily as a structure for holding the plurality of vertical supports 9 together, but also provides a surface for attaching advertisements. Moreover, the header unit 1 may also support products if a grate is place or panel is placed upon the header unit 1. The at least one shelf 2 also helps to hold the present invention together, but is used to support a grate or panel designed for holding products.

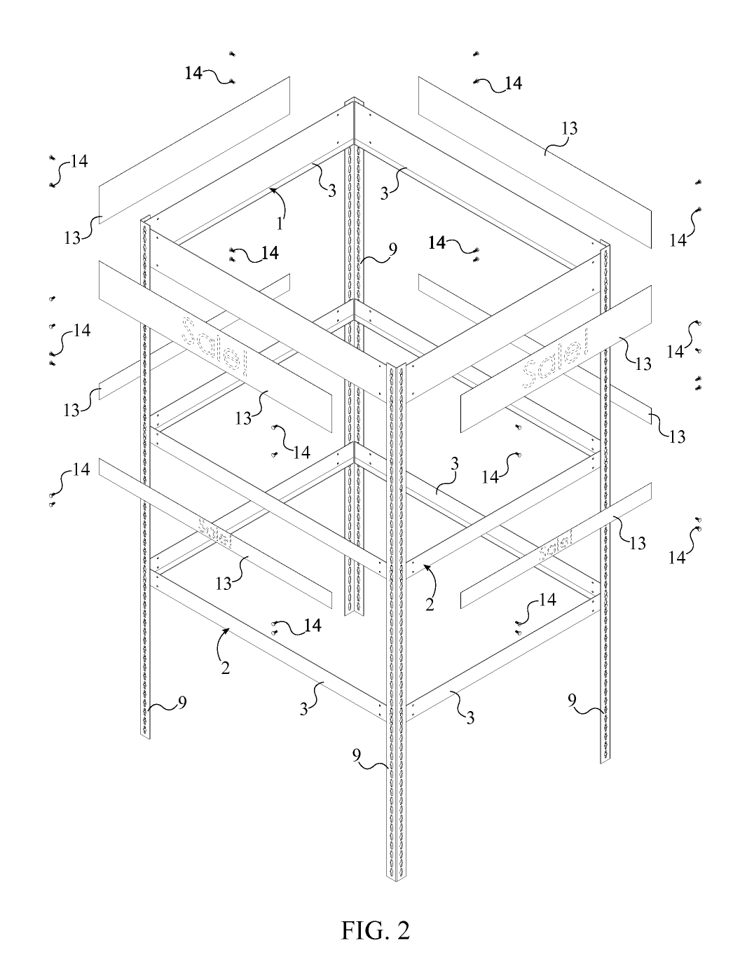

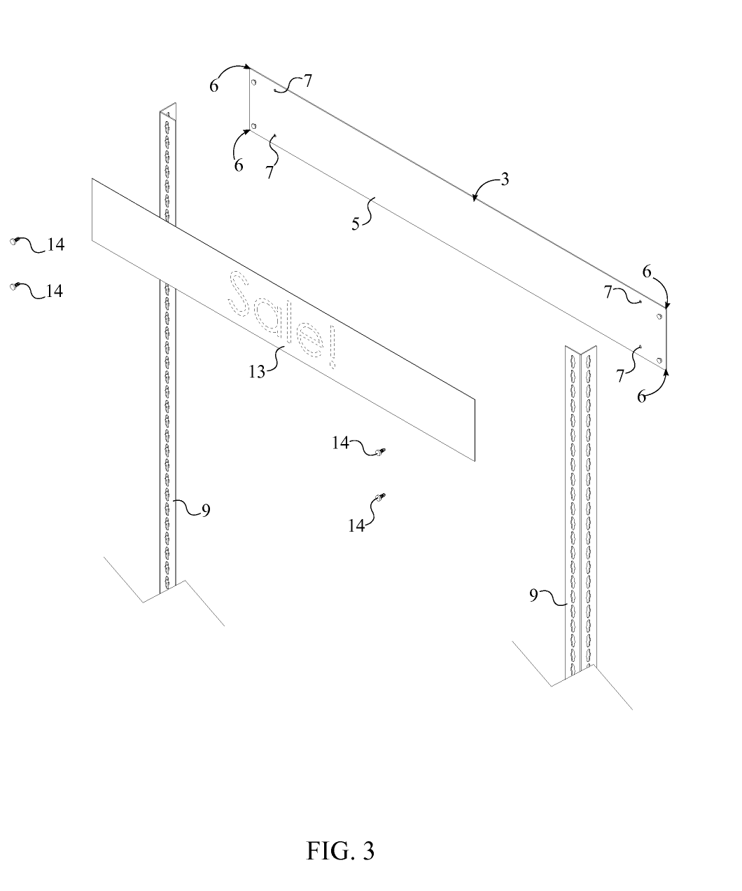

In reference to FIGS. 2-3, the header unit 1 and each of the at least one shelf 2 each comprises a plurality of lateral cross members 3. The header unit 1 and the at least one shelf 2 are distributed along a height 10 for the plurality of vertical supports 9. The header unit 1 and the at least one shelf 2 may be spaced apart to account for the size of products held on the at least one shelf 2. Each of the lateral cross members 3 is mounted in between two adjacent supports from the plurality of vertical supports 9. In the preferred embodiment of the present invention, each of the plurality of lateral cross members 3 has a number of rivets which engage with holes in the vertical supports 9. This type of shelving structure should be well known to those skilled in the art. Each of the plurality of advertisement assemblies 12 is attached along a corresponding selected member from the plurality of lateral cross members 3. Depending on the situation, the user may choose to place the plurality of advertisement assemblies 12 on some or all of the lateral cross members 3. The plurality of advertisement assemblies 12 is used to enhance the display of products and/or attract customer attention.

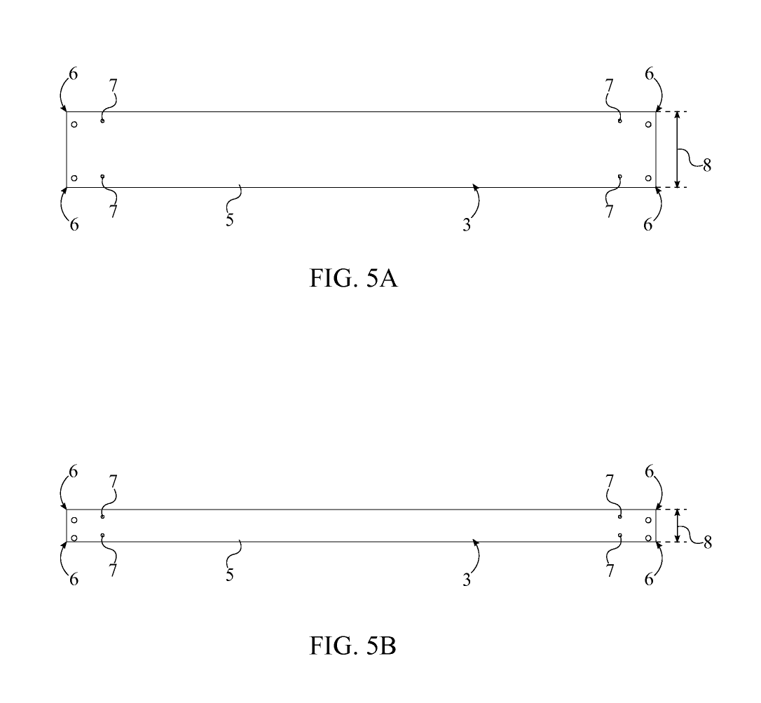

In reference to FIG. 2 and FIG. 5, each of the plurality of lateral cross members 3 comprises a structural panel 5 and a plurality of fastener holes 7. The structural panel 5 is used to help support the weight of products stored on the present invention and helps to keep the present invention together. The plurality of fastener holes 7 traverses normal and through the structural panel 5 and is used to secure a single advertisement assembly to the structural panel 5. In the preferred embodiment of the present invention, each of the plurality of fastener holes 7 is positioned adjacent to a corresponding corner 6 of the structural panel 5. In additional embodiments of the present invention, the plurality of fastener holes 7 may be placed anywhere on the structural panel 5.

In reference to FIGS. 2-3, each of the plurality of advertisement assemblies 12 comprises a sheet body 13 and a plurality of fasteners 14. The sheet body 13 provides graphics or words which are used to advertise products which may be displayed by the present invention. The sheet body 13 is mounted across the structural panel 5 of the corresponding selected cross member by the plurality of fasteners 14. In the preferred embodiment, the plurality of fasteners 14 is push-in finned clips which may be easily attached and detached from the structural panel 5 of a selected cross member. In alternative embodiments of the present invention, the plurality of fasteners 14 may resemble bolts, pins or any other similar fastener type. Each of the plurality of fasteners 14 is engaged to a respective fastener hole of the corresponding selected cross member. The plurality of fasteners 14 may either puncture through the sheet body 13 or traverses through pre-punched holes.

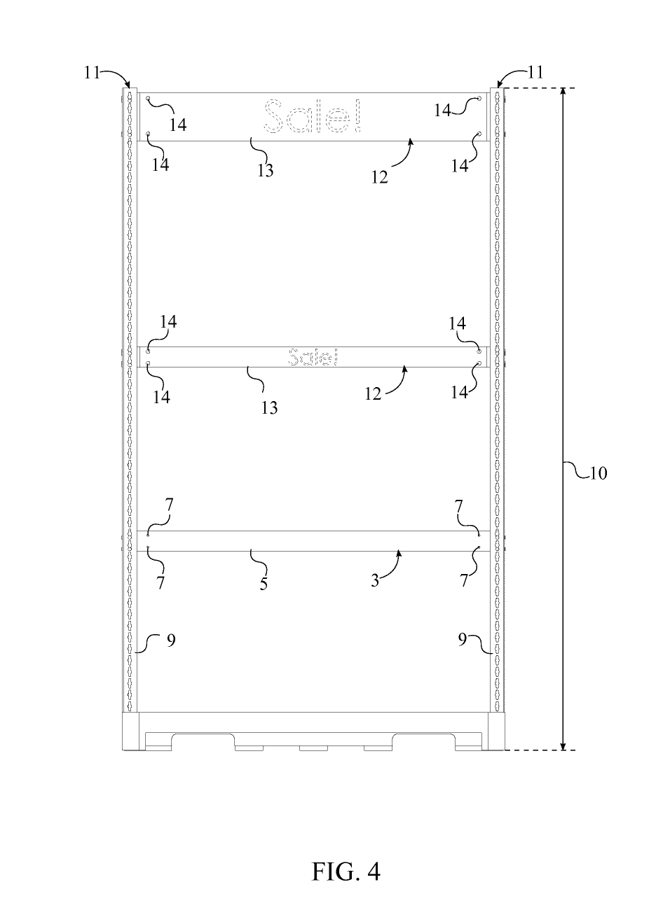

Because the header unit 1 is primarily used for display, it is preferred that a width 8 for each of the plurality of lateral cross members 3 for the header unit 1 is greater than a width 8 for each of the plurality of lateral cross members 3 for the at least one shelf 2. As shown in FIGS. 4-5, this creates a larger display area to aid in attracting consumers. The plurality of lateral cross members 3 for the header unit 1 is positioned adjacent to a top end 11 for each of the plurality of vertical supports 9. This also aids in attracting consumers because placing the header unit 1 in an elevated position reduces the chance that the header unit 1 becomes obstructed from the view of consumers while on display.

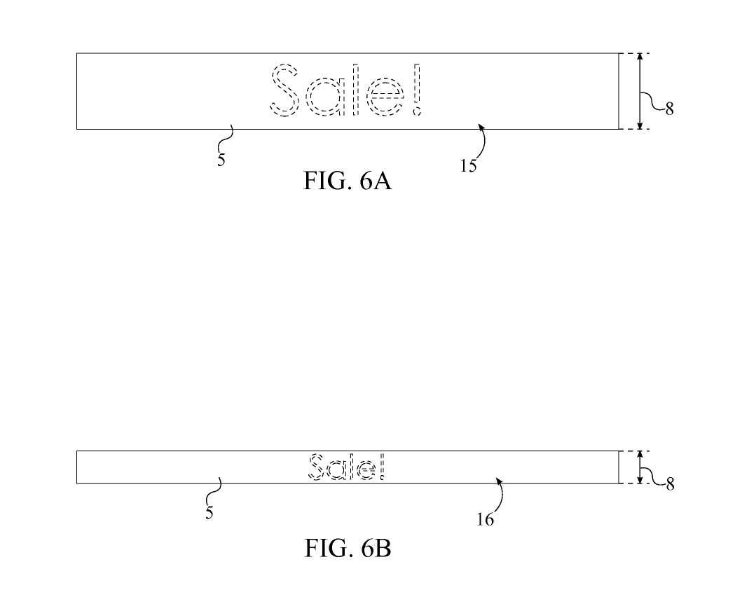

Because the header unit 1 and the at least one shelf 2 vary in size, it is necessary that the plurality of advertisement assemblies 12 comprises a plurality of header advertisement assemblies 15 and a plurality of shelf advertisement assemblies 16. In reference to FIG. 6, a sheet body 13 width 8 for each of the plurality of header advertisement assemblies 15 is greater than a width 8 for each of the plurality of shelf advertisement assemblies 16 This size difference is intended to be scaled relative to that of the header unit 1 and the at least one shelf 2.

Although the invention has been explained in relation to its preferred embodiment, it is to be understood that many other possible modifications and variations can be made without departing from the spirit and scope of the invention as hereinafter claimed.

What is claimed is:

1. An advertisement shelving unit comprises:
a header unit;
at least one shelf;
a plurality of vertical supports;
a plurality of advertisement assemblies;
the header unit and each of the at least one shelf each comprises a plurality of lateral cross members;
the header unit and the at least one shelf being distributed along a height for the plurality of vertical supports;
each of the plurality of lateral cross members being mounted in between two adjacent supports from the plurality of vertical supports; and
each of the plurality of advertisement assemblies being attached along a corresponding selected member from the plurality of lateral cross members.

2. The advertisement shelving unit as claimed in claim 1 comprises:
each of the plurality of lateral cross members comprises a structural panel and a plurality of fastener holes;
the plurality of fastener holes traversing normal and through the structural panel; and
each of the plurality of fastener holes being positioned adjacent to a corresponding corner of the structural panel.

3. The advertisement shelving unit as claimed in claim 1 comprises:
each of the plurality of advertisement assemblies comprises a sheet body and a plurality of fasteners; and
the sheet body being mounted across a structural panel of the corresponding selected member by the plurality of fasteners.

4. The advertisement shelving unit as claimed in claim 3 comprises:
each of the plurality of fasteners being engaged to a respective fastener hole of the corresponding selected member.

5. The advertisement shelving unit as claimed in claim 3, wherein each of the plurality of fasteners being a push-in finned clip.

6. The advertisement shelving unit as claimed in claim 1 comprises:
a width for each of the plurality of lateral cross members for the header unit being greater than a width for each of the plurality of lateral cross members for the at least one shelf; and
the plurality of lateral cross members for the header unit being positioned adjacent to a top end for each of the plurality of vertical supports.

7. The advertisement shelving unit as claimed in claim 1 comprises:
the plurality of advertisement assemblies comprises a plurality of header advertisement assemblies and a plurality of shelf advertisement assemblies; and
a sheet body width for each of the plurality of header advertisement assemblies being greater than a width for each of the plurality of shelf advertisement assemblies.

8. An advertisement shelving unit comprises:
a header unit;
at least one shelf;
a plurality of vertical supports;
a plurality of advertisement assemblies;
the header unit and each of the at least one shelf each comprises a plurality of lateral cross members;
each of the plurality of advertisement assemblies comprises a sheet body and a plurality of fasteners;
the header unit and the at least one shelf being distributed along a height for the plurality of vertical supports;
each of the plurality of lateral cross members being mounted in between two adjacent supports from the plurality of vertical supports;
each of the plurality of advertisement assemblies being attached along a corresponding selected member from the plurality of lateral cross members; and
the sheet body being mounted across a structural panel of the corresponding selected member by the plurality of fasteners.

9. The advertisement shelving unit as claimed in claim 8 comprises:
each of the plurality of lateral cross members comprises a structural panel and a plurality of fastener holes;
the plurality of fastener holes traversing normal and through the structural panel; and
each of the plurality of fastener holes being positioned adjacent to a corresponding corner of the structural panel.

10. The advertisement shelving unit as claimed in claim 8 comprises:
each of the plurality of fasteners being engaged to a respective fastener hole of the corresponding selected member.

11. The advertisement shelving unit as claimed in claim 8, wherein each of the plurality of fasteners being a push-in finned clip.

12. The advertisement shelving unit as claimed in claim 8 comprises:
a width for each of the plurality of lateral cross members for the header unit being greater than a width for each of the plurality of lateral cross members for the at least one shelf; and
the plurality of lateral cross members for the header unit being positioned adjacent to a top end for each of the plurality of vertical supports.

13. The advertisement shelving unit as claimed in claim 8 comprises:
the plurality of advertisement assemblies comprises a plurality of header advertisement assemblies and a plurality of shelf advertisement assemblies; and
a sheet body width for each of the plurality of header advertisement assemblies being greater than a width for each of the plurality of shelf advertisement assemblies.

14. An advertisement shelving unit comprises:
a header unit;
at least one shelf;
a plurality of vertical supports;
a plurality of advertisement assemblies;
the header unit and each of the at least one shelf each comprises a plurality of lateral cross members;
each of the plurality of lateral cross members comprises a structural panel and a plurality of fastener holes;
each of the plurality of advertisement assemblies comprises a sheet body and a plurality of fasteners;
the header unit and the at least one shelf being distributed along a height for the plurality of vertical supports;
each of the plurality of lateral cross members being mounted in between two adjacent supports from the plurality of vertical supports;
each of the plurality of advertisement assemblies being attached along a corresponding selected member from the plurality of lateral cross members;
the plurality of fastener holes traversing normal and through the structural panel;
each of the plurality of fastener holes being positioned adjacent to a corresponding corner of the structural panel; and
the sheet body being mounted across a structural panel of the corresponding selected member by the plurality of fasteners.

15. The advertisement shelving unit as claimed in claim 14 comprises:
each of the plurality of fasteners being engaged to a respective fastener hole of the corresponding selected member.

16. The advertisement shelving unit as claimed in claim 14, wherein each of the plurality of fasteners being a push-in finned clip.

17. The advertisement shelving unit as claimed in claim 14 comprises:
a width for each of the plurality of lateral cross members for the header unit being greater than a width for each of the plurality of lateral cross members for the at least one shelf; and
the plurality of lateral cross members for the header unit being positioned adjacent to a top end for each of the plurality of vertical supports.

18. The advertisement shelving unit as claimed in claim 14 comprises:
the plurality of advertisement assemblies comprises a plurality of header advertisement assemblies and a plurality of shelf advertisement assemblies; and
a sheet body width for each of the plurality of header advertisement assemblies being greater than a width for each of the plurality of shelf advertisement assemblies.
